(19) United States
(12) Patent Application Publication
(10) Pub. No.: US 2011/0192257 A1
(43) Pub. Date: Aug. 11, 2011

(54) Hydraulic Bolt Tensioner and Nut

(75) Inventor: Peter Armstrong, Strongsville, OH (US)

(73) Assignee: TITAN TECHNOLOGIES INTERNATIONAL, INC., Houston, TX (US)

(21) Appl. No.: 13/023,390

(22) Filed: Feb. 8, 2011

Related U.S. Application Data
(60) Provisional application No. 61/302,914, filed on Feb. 9, 2010.

(51) Int. Cl. B25B 29/02

(52) U.S. Cl. 81/57.38

(57) ABSTRACT

A hydraulic bolt tensioner has a reduced height by virtue of inner seals between a cylinder and piston being aligned along a same plane. The tensioner also has a reduced width by virtue of carbon fiber would about the tensioner's housing, reducing the need for a certain thickness of material used for the tensioner's housing.

### CROSS-REFERENCE TO RELATED APPLICATIONS

This is a non-provisional of U.S. Provisional Appl. Ser. No. 61/302,914, filed 9 Feb. 2010, which is incorporated herein by reference and to which priority is claimed.

### BACKGROUND

In bolting applications, the various bolts are preferably preloaded for a specific set of operating conditions to improve bolt fatigue life, increase joint rigidity, and reduce bolt relaxation, joint separation, and joint slippage. To achieve required preload, operators can use a hydraulic bolt tensioner to apply a direct axial load to a bolt to be tensioned. FIG. 1 shows a typical hydraulic tensioning system having a tensioner pump coupled to various hydraulic bolt tensioners by a feed hose and link lines. The tensioners thead on bolts used to connect flanges together. When hydraulic fluid is pumped to the tensioners, the tensioners preload the bolts.

FIGS. 2-3 show typical hydraulic bolt tensioners 10A-B according to the prior art. Each of these tensioners 10A-B has a puller 20, a piston 30, a cylinder 40, a bridge 50, and a socket 60. The socket 60 fits on a nut 70, and the bridge 50 fits around the socket 60 and rests upon a surface (not shown) through which a bolt 72 to be tensioned passes. The cylinder 40 mounts on top of the bridge 50, and the piston 30 positions in the top of the cylinder 30. Finally, the puller 20, which can be sized for the particular bolt 72, threads onto the bolt 72 and fits inside the piston 30.

Once assembled, the tensioner 10 can preload the bolt 72. The hydraulic pump (FIG. 1) applies pressure through a port 44 in the cylinder 40. The pressure acts against the interface 45 between the cylinder 40 and piston 30. A seal 42 on the cylinder 40 and a seal 32 on the piston 30 help maintain the pressure at the interface. As a result, the piston 30 moves and forces the puller 20 threaded on the bolt 72. This applies an axial load along the center line of the bolt 72. Once a desired preload is achieved, the nut 70 may be tightened (e.g., either by hand or with tools), the pressure released, and the hydraulic bolt tensioner 10 disengaged from the bolt 72.

The seals 32/42 in FIG. 3 have one seal 32 on the piston 30 and one 42 on the cylinder 40. Yet, this arrangement increases the bolt tensioner's required height because the length of the components must accommodate these seals. The tensioner 10 in FIG. 2 has only seals 32 on the piston 30. Use of these seals 32 alone may not provide adequate sealing. Moreover, use of the seals 32 in this arrangement increases the overall width that the tensioner 10 must have.

The preloads applied during hydraulic bolt tensioning can be as high as or higher than 1,000,000 lbs. Yet, using bolt tensioners in some implementations may have restricted space so that the tensioner cannot be made as bulky as desired. Therefore, use of the tensioner for certain preloads may be limited by the available space at an installation and by the safety considerations involved.

FIG. 4 shows a prior art hydraulic nut 10C. The arrangement of the nut 100 is similar to that of the tensioner 10B in FIG. 3. The nut 10C has a piston 90 that threads onto the bolt 72 and fits into a cylinder 80. A cap 98 is also used and threads onto the piston 90. Hydraulic fluid is communicated through a port 96 in the piston 90 to an interface 95 between the piston 90 and cylinder 80. As with the bolt tensioner 10B of FIG. 3, the interface 95 on the hydraulic nut 100 of FIG. 4 has seals 82/94 in an arrangement that increases the overall height of the hydraulic nut 100.

Although common in the industry, the construction for existing hydraulic tensioners and hydraulic nuts has limitations. For example, their construction increases the overall width and height of these devices, which may limit their usefulness in some situations. For reference, FIG. 5 diagrams a typical arrangement where a tensioner or nut may be used on a nut 70A-B or bolt 72. As shown, a bolt 72 passes through two flanges 74/76, and upper and lower nuts 70A-B thread onto the bolt 72 to hole the flanges 74/76 together. In some circumstances, an obstruction 78 may lie in close proximity to the flanges 74/76. This can lead to a reduced height clearance H between the flange 74, nut 70A, and exposed end of the bolt 72 that can limit access of a conventional hydraulic tensioner or hydraulic nut. In addition, a feature (diameter change, shoulder, sidewall, chamfer, etc.) close to the nut 70A on the flange 74 may reduced a depth clearance D around the nut 70A that can limit access of the conventional hydraulic tensioner or hydraulic nut.

The subject matter of the present disclosure is directed to overcoming, or at least reducing the effects of, one or more of the problems set forth above.

### SUMMARY

A hydraulic bolt tensioner has a socket, a bridge, a cylinder, a piston, and a puller. The socket disposes on a nut threaded on a bolt, and the bridge supports the tensioner on a surface. The cylinder fits onto the bridge, and the piston disposes in the cylinder. Finally, the puller threads onto the bolt to be preloaded and engages in the piston.

To reduce the overall height required for the tensioner, the interfacing surfaces between the cylinder and the piston are slanted, and the seal on the cylinder and the seal on the piston lie on the same plane when the piston is in its full downward position in the tensioner. Having a reduced height, the tensioner can be used at locations having a tighter clearance above a bolt to be preloaded.

To reduce the overall width required for the tensioner, the outside surface of the cylinder has a pocket with carbon fiber filament wound therein. The fiber is wound around the sidewall at the top of the cylinder where the piston fits in the cylinder. Use of the carbon fiber reduces the chances of this sidewall from deflecting during operation and also enables the thickness of this sidewall (and overall width of the tensioner) to be reduced. Having such a reduced width, the tensioner can be used at locations having a tighter clearance around a bolt to be preloaded.

A multi-stage tensioner disclosed herein also uses carbon fiber wound around the outside of the tensioner's housing to both strength particular areas adjacent fluid chambers therein and other areas that may experience dilation due to forces generated and to reduce the overall width of the tensioner. This multistage tensioner can also include a cap enclosing a pressure chamber for holding gas, such as air, above the upper most piston in the tensioner. This gas chamber can be used as a return mechanism for the puller and may require less space then the conventional springs used in the art.

The foregoing summary is not intended to summarize each potential embodiment or every aspect of the present disclosure.

### BRIEF DESCRIPTION OF THE DRAWINGS

FIG. 1 illustrates a typical hydraulic bolt tensioning system.

FIG. 2 shows a prior art hydraulic bolt tensioner preloading a bolt.

FIG. 3 shows another prior art hydraulic bolt tensioner preloading a bolt.

FIG. 4 shows a prior art hydraulic nut.

FIG. 5 diagrams a typical nut location subject to tight clearances.

FIG. 6A shows a hydraulic bolt tensioner according to the present disclosure.

FIG. 6B is a cross-section of the disclosed hydraulic bolt tensioner.

FIG. 7A shows a hydraulic nut according to the present disclosure.

FIG. 7B is a cross-section of the disclosed hydraulic nut.

FIG. 8A shows a multi-stage hydraulic bolt tensioner according to the present disclosure.

FIG. 8B is a cross-section of the multi-stage hydraulic bolt tensioner.

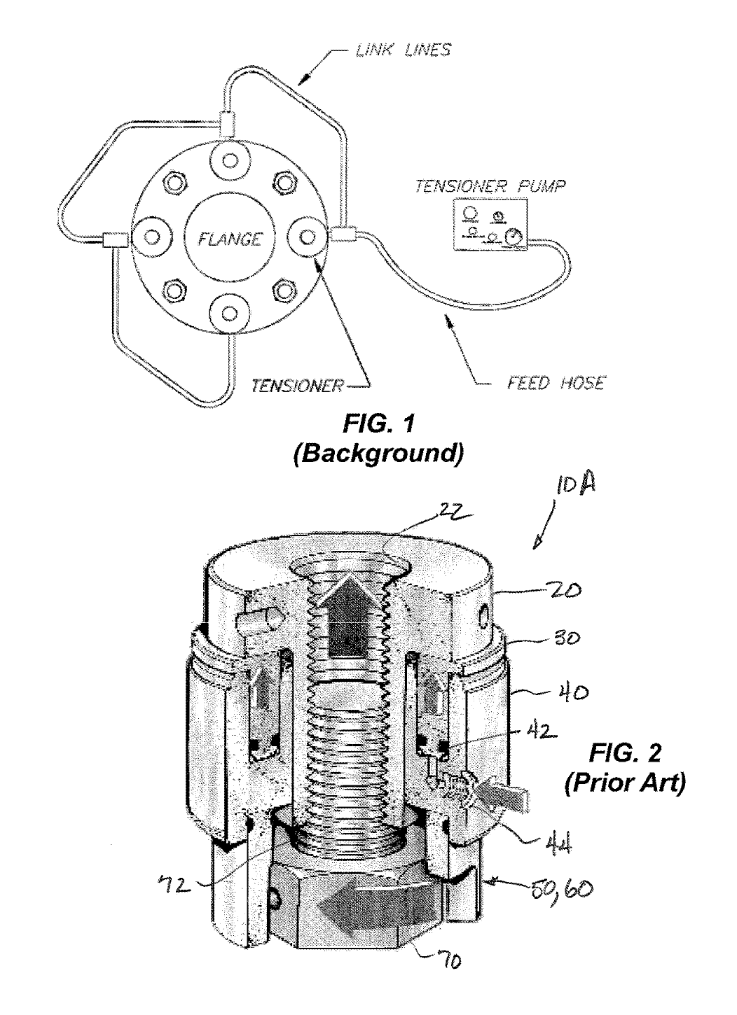

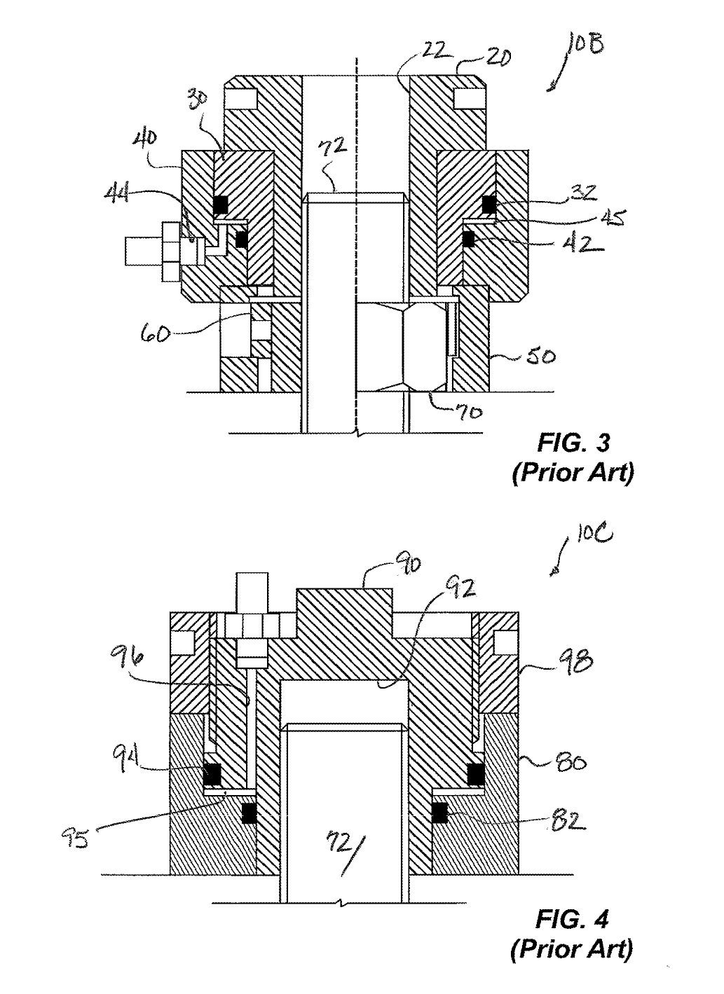

### DETAILED DESCRIPTION

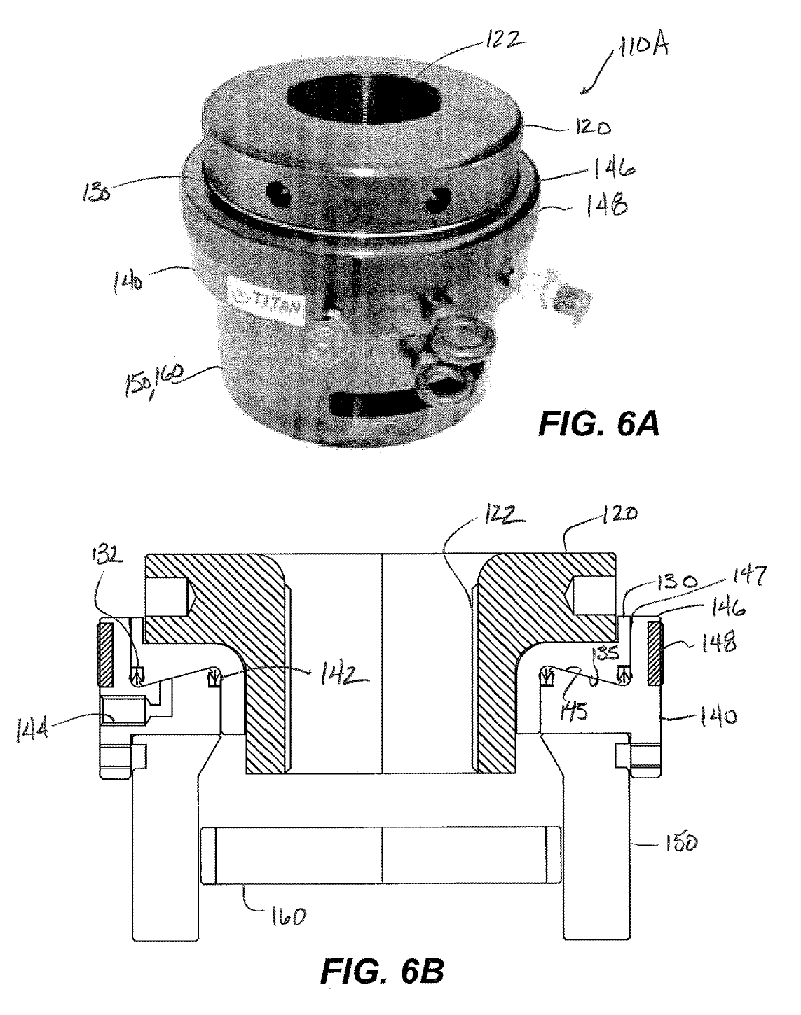

Referring to FIGS. 6A-6B, a bolt tensioner 110 according to the present disclosure has a puller 120, a piston 130, a cell or cylinder 140, a bridge 150, and a socket 160. As described previously, the socket 160 fits on a nut 70, and the bridge 150 fits around the socket 160 and rests upon a surface (not shown) through which a bolt 72 to be tensioned passes. The particular bridge 150 used on the tensioner 110 can be changed depending on the size of the nut.

The cylinder 140 mounts on top of the bridge 150, and the piston 130 positions in the top of the cylinder 30. Finally, the puller 120, which can be sized for the particular bolt 72, threads onto the bolt 72 and fits inside the piston 130. Once assembled, the tensioner 10 can preload the bolt 72 by the operations outlined previously.

In contrast to the prior art tensioners described in the Background, the disclosed tensioner 110 has several features that help reduce the overall size (width and height) of the tensioner 110. As best shown in FIG. 6B, the piston 130 has an outside seal 132 disposed at an outer edge. In addition, the piston 130 has an upward slanting interface 135 extending from this outer edge to an inner edge of the piston 130. A central wall of the piston 130 extends downward from this inner edge into the bore through the cylinder 140.

The cylinder 140 has a reverse arrangement. In particular, the cylinder 140 has an inside seal 132 disposed at an inside edge. In addition, the cylinder 140 has an downward slanting interface 145 extending from this inner edge to an outer edge of the cylinder 140. When hydraulic fluid enters port 144, the pressure builds between the interfaces 135/145, and the seals 132/142 maintain the pressure in this annulus. The building pressure then forces the piston 130 upward, pushing the puller 120 along and preloading the bolt (not shown).

When the piston 130 is fully seated as shown in FIG. 6B, the two seals 132/142 engage in the opposing corner of the other element 130/140, and the two slanting interfaces 135/145 fit with one another. This allows the two seals 132/142 to lie along the same plane perpendicular to the axis of the tensioner 110. This reduces the overall height that the tensioner 110 must have to accommodate the needed sealing between the piston 130 and cylinder 140.

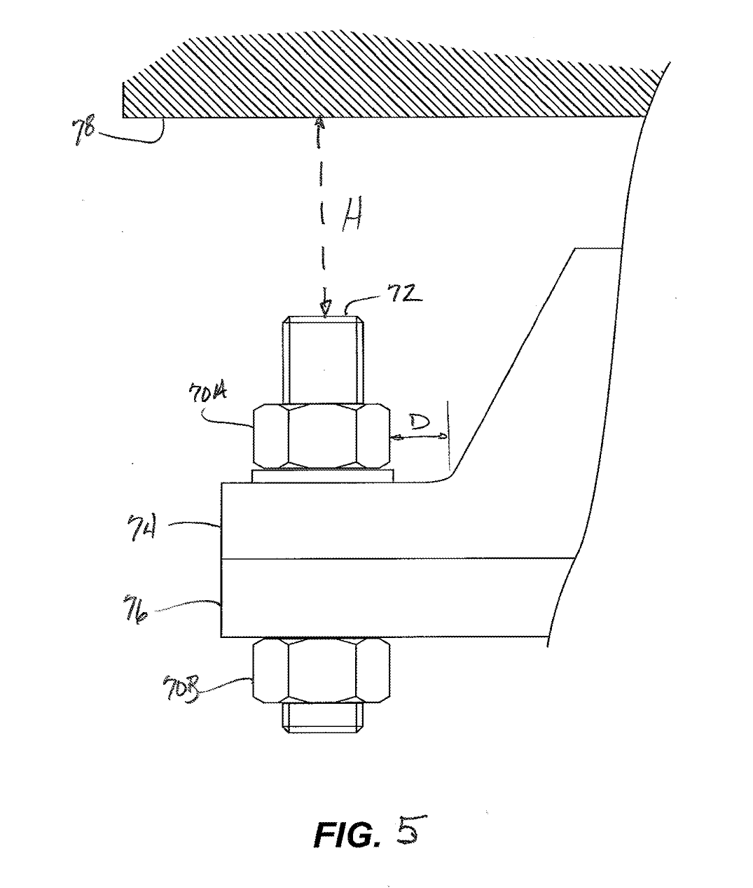

As noted previously, being able to reduce the required height of the tensioner 110 enables the tensioner 110 to be used in situations where less clearance is available, such as shown in FIG. 5 where an obstruction 78 above the end of the bolt 72 limits clearance. Because the puller 120 receives a significant load, decreasing the height of the shoulder around the puller 120 may not be a suitable option for altering the height of the tensioner. Therefore, having the seals 132/142 lying on the sample plane and having interfaces 135/145 with the slanted fit reduces the height of the tensioner 110A without the need to some axial dimensions of such components as the puller 120 and the like.

Typically, as shown in the disclosed cylinder 140 of FIG. 6B, the top of the cylinder 140 has a surrounding wall 146. During operation, high loads and stresses can act against the upper portion of the cylinder 140, as the piston 130 is forced upward and the pushed puller 120 preloads the bolt (not shown). These loads and stresses act against the surrounding wall 146. Yet, the tensioner 110A must fit within limited spaces between nuts and bolts around a flange or the like. Therefore, size restrictions limit the thickness that this wall 146 can have as well as the overall width that the tensioner 110A can have.

As shown in FIG. 6B, a carbon fiber reinforcement 148 is disposed in a circumferential pocket around the outside of the cylinder 140 at this upper wall 146. This carbon fiber reinforcement 148 reduces the required thickness of this outer wall 146 (and the overall width of the tensioner 110), while also reinforcing the hoop strength of this wall 146 to resist deflection and other undesirable effects. The carbon fiber reinforcement 148 can be a filament wound around the cylinder 140 in this pocket, although other implementations could use a woven fiber or other arrangement. The wound carbon fiber filament may increase the hoop strength of this wall 146 significantly above levels achievable with the standard material used for the cylinder 140. Thus, the wound carbon fiber filament can reduce the deflection that can occur in this upper wall 146, while allowing the overall width of the tensioner 11OA to be reduced.

As a further detail, the upper inside edge of this wall 146 defines a scallop 147 thereabout. When the piston 130 is moved in of the cylinder 140, the seal 132 can pass this scallop 147, which can help prevent extruding, cutting or damaging the seal while under hydraulic pressure. Furthermore, the venting of the hydraulic fluid prevents the piston from overstroking and the seal extruding, which would damage the seal and render the device unserviceable. For example, when the piston 130 is removed from the cylinder 140, the scallop 147 may allow any trapped or remaining fluid to escape without extruding the seal 132, which could damage it. Also, when the piston 130 inserts into the cylinder 140, the scallop 147 may prevent the seal 132 from being cut.

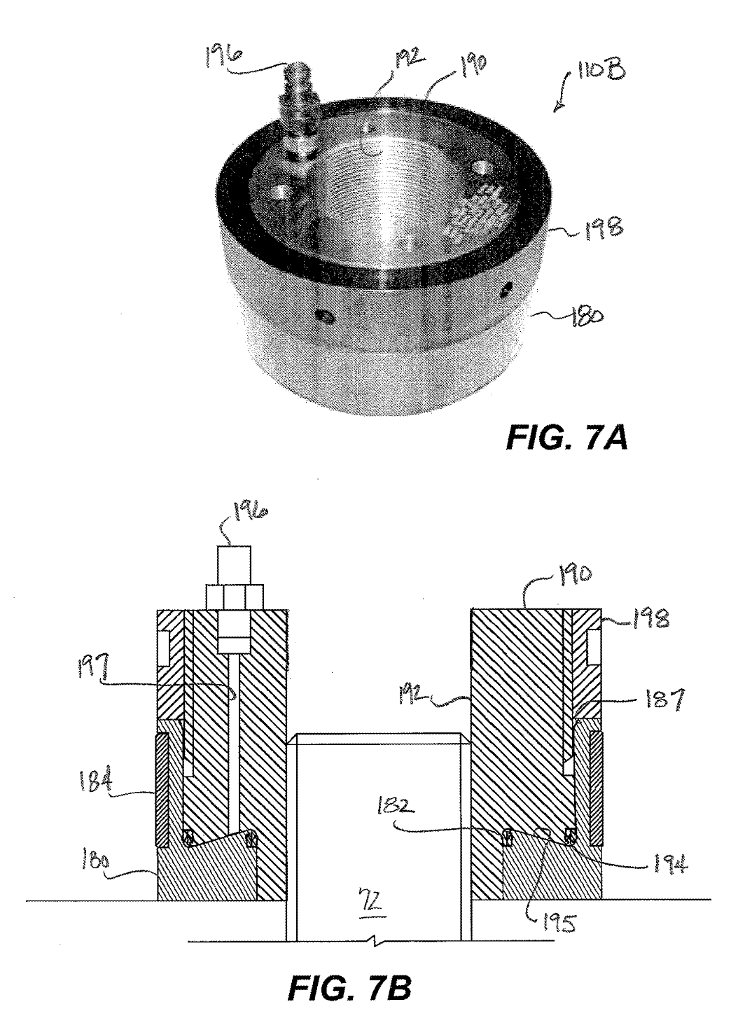

FIGS. 7A-7B show a similar arrangement for a hydraulic nut 110B according to the present disclosure. The hydraulic nut 100B has a piston 190 that threads onto the bolt 72 and fits into a cylinder 180. A cap 198 is also used and threads onto the piston 190. Hydraulic fluid is communicated through a nipple 196 and a port 197 in the piston 190 to the interfaces 185/195 between the piston 190 and cylinder 180.

As with the bolt tensioner 110A of FIGS. 6A-6B, the piston 190 has an outside seal 194 disposed at an outer edge and has an upward slanting interface 195 extending from this outer edge to an inner edge of the piston 190. A central wall of the piston 130 extends downward from this inner edge into the bore through the cylinder 180.

The cylinder 180 has a reverse arrangement. In particular, the cylinder 180 has an inside seal 182 disposed at an inside edge and has an downward slanting interface 185 extending from this inner edge to an outer edge of the cylinder 180. When hydraulic fluid enters port 196, the pressure builds between the interfaces 185/195, and the seals 182/194 maintain the pressure in this annulus. The building pressure then forces the piston 190 upward, loading the bolt 72.

When the piston 190 is fully seated as shown in FIG. 7B, the two seals 182/194 engage in the opposing corner of the other element 180/190, and the two slanting interfaces 185/195 fit with one another. This allows the two seals 182/194 to lie along the same plane perpendicular to the axis of the hydraulic nut 110B. This reduces the overall height that the hydraulic nut 110B must have to accommodate the needed sealing between the piston 190 and cylinder 180. As also shown, the cylinder 180 includes a scallop 187 at its upper edge to protect the seal 194 when passed into and out of the cylinder 180.

As shown in FIG. 7B, a carbon fiber reinforcement 184 is disposed in a circumferential pocket around the outside of the cylinder 180. This carbon fiber reinforcement 184 reduces the required thickness of the outer wall around the interfaces 185/195 (and the overall width of the hydraulic nut 110B), while also reinforcing the hoop strength of this portion of the cylinder 180 to resist deflection and other undesirable effects. Again, the carbon fiber reinforcement 184 can be a filament wound around the cylinder 180 in this pocket, although other implementations could use a woven fiber or other arrangement.

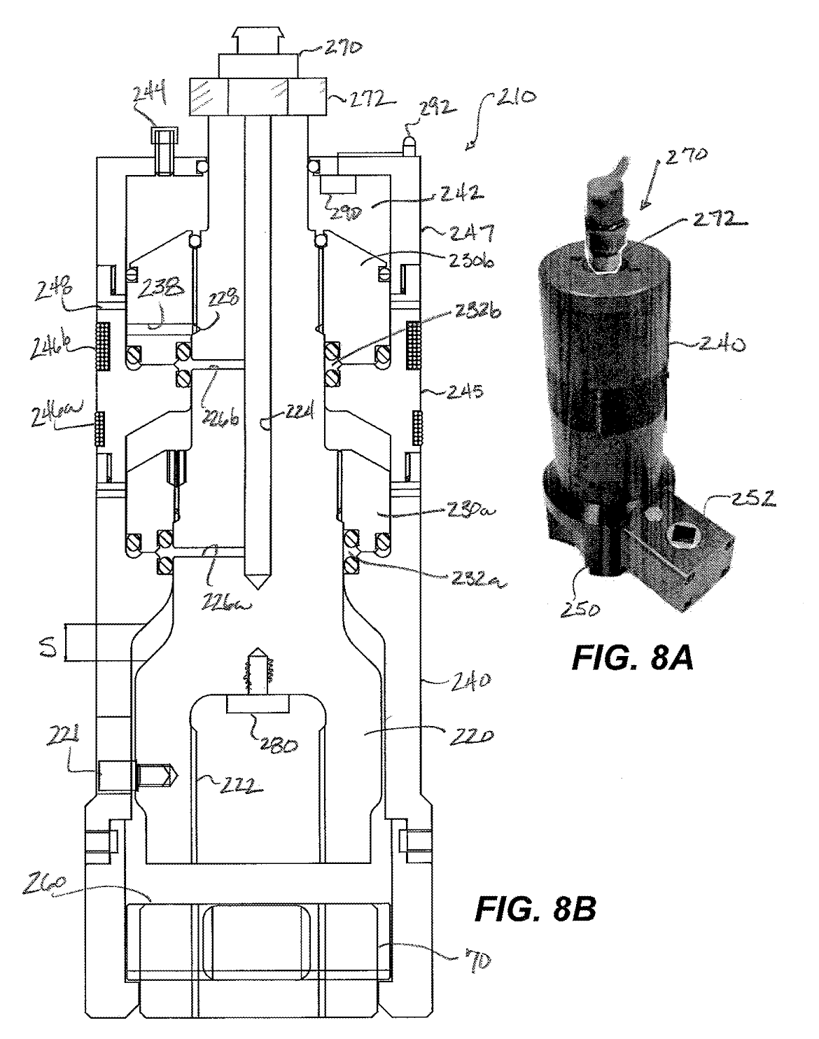

A multi-stage hydraulic bolt tensioner 210 is shown in FIGS. 8A-8B. Inside as shown in FIG. 8B, the tensioner 210 has a puller 220, pistons 230a-b, a housing 240, a bridge 250, and a socket 260. Outside as shown in FIG. 8A, the tensioner 210 has a ratchet mechanism 252 attached at the tensioner's lower end for manually turning the nut on the bolt after tensioning. In general, the ratchet mechanisms 252 can receive the end of a socket wrench and can have gears.

As also shown in FIG. 8A, the tensioner 210 has a nipple 270 with a nut 272 for hydraulics attached to the top of the puller 220 and exposed beyond the top of the tensioner 210. The external nut 272 at the puller's upper end can be used for manually threading the puller 220 off the bolt once preloaded. The nipple 270 can be used to feed hydraulic fluid into the puller 220 as described below. With this arrangement, the tensioner 210 does not require a manifold on the side that can limit what spaces in which the tensioner can be used.

As with the previously described single-stage tensioner, the socket 260 held by the bridge 250 fits onto a nut 70, and the puller 220 disposed in the housing 240 threads onto the bolt (not shown) to be preloaded. As such, the puller 220 has a threaded end 222 for threading onto the bolt. Further up the puller 220, the pistons 230a-b thread in stages onto the puller 220.

A cell 245 attaches to the housing 240. This cell 245 completes the first stage of the tensioner 210 by enclosing the lower piston 230a in the lower chamber 232a. This cell 245 also starts the second stage of the tensioner 210 by creating the separation for the next higher piston 230b and chamber 232b. If additional stages are to be used, then additional cells 245 and pistons 230 can be stacked on top of one another along a puller 220 having additional length.

A central passage 224 and side passages 226a-b defined through the puller 220 supply hydraulic pressure to piston chambers 232a-b. Although not shown, the upper end of the puller 220 has a hydraulic coupling (not shown) that connects to a source of hydraulic fluid. This coupling can use conventional components.

Typically, prior art multi-stage tensioners have charge ports defined in the side of each cell where hydraulic fluid is supplied. The current arrangement of the disclosed tensioner 210 has benefits over such a conventional arrangement. In particular, having the hydraulic fluid pass through the puller 220 through passages 224/226a-b can reduce the overall width of the tensioner 210 because separate side couplings for hydraulic fluid need not be supplied on the sides of the tensioner 210 to supply the chambers 232a-b with hydraulic fluid.

The tensioner 210 includes a number of sealing elements to seal where the pistons, housings, and other components interface to maintain fluid pressure integrity. When supplied with hydraulic fluid, the pressure in the chambers 232a-b force the pistons 230a-b and attached puller 220 upward to preload the threaded bolt. The stroke of the puller 220 is limited as shown at S, and an indicator 221 can be used on the outside of the housing 240. Although not shown, the tensioner 210 may have one or more fluid release valves (not shown) connected to output ports to release fluid from the chambers 232a-b.

As shown, the cell 245 has a carbon fiber 246a filament woven in a pocket around the cell. This woven fiber 246a is positioned near the lower end of the cell, because this location is susceptible to deflection and possible failure when hydraulic pressure fills piston chamber 232b. An addition carbon fiber 246b filament is woven around the upper end of the cell 245 as well to reduce deflection and possible failure. Additionally, as noted previously, use of the carbon fiber 246a-b permits the housing 240 and cells 245 to have a reduced width to fit in tighter clearances while still providing sufficient strength.

A cap 247 attaches to the top cell 245 of the tensioner 210. This cap 247 defines a pnuematic chamber 242 fed with pressurized gas through a port 244. To keep the gas pressure in the chamber 242, a central seal seals against the outside of the puller 220, and seals on the upper piston 230b seal against both the puller 220 and the cap 247. The pnuematic chamber 242 operates as a return mechanism for returning the puller 220 to an initial position when hydraulic pressure is released. Typically, a multi-stage tensioner has a spring return mechanism disposed above the puller 220. This requires a significant amount of space to accommodate springs. At the pinnacle of its stroke, fluid pressure in chambers 232a-b may discharge through ports 248a-b.

The seals around the puller 220 at the upper cylinder 230b may leak because they seal gas on one side and hydraulic fluid on the other. Therefore, a cross-port 238 can be defined through the cylinder 230b to allow any mixture of gas and fluid to escape through side port 248. If desired, another charging port can be defined in the cell 245 to charge the area of the chamber 232a above the lower piston 230a with gas to pneumatically return the puller 220.

As shown in the lower end of the puller 220, an adjustable stop 280 can be provided for controlling engagement of the puller 220 onto a stud (not shown). This stop 280 can include an electrical contact or micro-switch coupled to an electronic indicator. When the puller 220 threads onto the stud to be preloaded, the contact of the stop 280 with the end of the stud can indicate proper placement of the puller 200 has been achieved. In addition, another electronic contact 290 can be provided at the top of the puller 220 to indicate an over-stroke condition. For example, if the puller 220 is lifted too much, portion of the puller 220 or piston 230b may contact the electronic contact 290, which may then activate an advisory indicator 292 showing that the puller 220 has over-stroked.

During operation, a bolt (not shown) may fail when the tensioner 210 preloads it. To limit the movement of the puller 220, a breakpoint 228 in the form of a groove is defined around the puller 220 at the lower end of where the upper piston 230b threads onto the puller 220. If certain stresses or limits are exceeded during operation, then the breakpoint 228 is designed to fail, thereby limiting the movement of the puller 220.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A hydraulic bolt tensioning apparatus, comprising:
a cell having a top and a bottom, the bottom supportable on a surface, the cell defining a central bore from the top to the bottom, the cell having an inner edge at the central bore and having a first ledge extending from the inner edge to an inner corner, the first ledge slanting at a downward angle from the inner edge to the inner corner, the top having a first sidewall extending from the inner corner, the cell defining a hydraulic pressure port communicating with the first ledge;
a first seal disposed on the inner edge;
a piston disposing in the cell, the piston having a central stem disposing in the first central bore of the cell and defining a second central bore, the piston having an inner corner at the central stem and having a second ledge extending from the inner corner to an outer edge, the second ledge slanting at a second downward angle from the inner corner to the outer edge, the piston having a second sidewall extending from the outer edge;
a second seal disposed on the outer edge, the first and second seals lying on a same plane when the first and second ledges lie adjacent one another; and
a puller disposing in the second central port of the piston and threading onto a bolt to be preloaded.

2. The apparatus of claim 1, wherein the first and second downward angles match one another.

3. The apparatus of claim 1, further comprising one or more bridges each disposing on the bottom of the cell to support it on the surface.

4. The apparatus of claim 3, further comprising one or more sockets each disposing in the bridge to engage a nut on the bolt to be preloaded.

5. The apparatus of claim 1, wherein the puller defines a first shoulder, and wherein the piston defines a second shoulder opposing the second ledge, the second shoulder engaging the first shoulder of the puller.

6. The apparatus of claim 1, wherein the cell comprises carbon fiber wound about an outer surface thereof.

7. The apparatus of claim 6, wherein the cell defines a pocket around the outer surface, the pocket having the carbon fiber wound therein.

8. The apparatus of claim 6, wherein the carbon fiber is wound about the outer surface at the first sidewall of the cell.

9. The apparatus of claim 1, further comprising a tensioner pump coupling to the port and supplying the hydraulic pressure thereto.

10. A hydraulic bolt tensioning apparatus, comprising:
a housing having a top and a bottom, the bottom supportable on a surface, the cell defining a central bore from the top to the bottom, the cell defining a plurality of chambers in the central bore; and
a puller disposed in the central bore and having a plurality of pistons disposed in the chambers, the puller having a threaded end threadable to a bolt to be preloaded, the puller having a passage communicating with the chambers, the passage delivering hydraulic fluid to the chambers for moving the puller in the housing, the housing having carbon fiber wound about an outer surface thereof adjacent a first of the chambers.

11. The apparatus of claim 10, wherein the housing defines a pocket around the outer surface, the pocket having the carbon fiber wound therein.

12. The apparatus of claim 10, wherein the carbon fiber is wound about the outer surface at a first location below where the housing defines a first ledge separating the first of the chambers from a second of the chamber disposed thereabove.

13. The apparatus of claim 12, wherein additional carbon fiber is wound about the outer surface at a second location above where the housing defines a second ledge separating the first and second chambers.

14. The apparatus of claim 10, wherein the housing comprises a cap disposed above a top one of the pistons disposed on the puller, the cap sealing around the puller and defining a third chamber for holding gas pressure.

15. The apparatus of claim 14, wherein the top piston defines a passageway communicating with the third chamber, the passageway communicating with an outer port in the housing when aligned therewith.

16. The apparatus of claim 10, further comprising one or more bridges each disposing on the bottom of the housing to support it on the surface.

17. The apparatus of claim 16, further comprising one or more sockets each disposing in the bridge to engage a nut on the bolt to be preloaded.

18. The apparatus of claim 10, further comprising a tensioner pump coupling to the port in the puller and supplying the hydraulic pressure thereto.

19. The apparatus of claim 10, wherein the pistons thread onto the puller.

20. The apparatus of claim 10, wherein the housing comprises:
a cylinder defining a first ledge and a first portion of a first of the chambers; and
a cell coupling to the cylinder and defining a second ledge, the second ledge enclosing a second portion of the first chamber and defining a portion of a second chamber.

21. A hydraulic nut, comprising:
a cell having a top and a bottom, the bottom supportable on a surface, the cell defining a central bore from the top to the bottom, the cell having an inner edge at the central bore and having a first ledge extending from the inner edge to an inner corner, the first ledge slanting at a downward angle from the inner edge to the inner corner, the top having a first sidewall extending from the inner corner, the cell defining a hydraulic pressure port communicating with the first ledge;
a first seal disposed on the inner edge;
a piston disposing in the cell and threading onto a bolt to be preloaded, the piston having a central stem disposing in the first central bore of the cell and defining a second central bore, the piston having an inner corner at the central stem and having a second ledge extending from the inner corner to an outer edge, the second ledge slanting at a second downward angle from the inner corner to the outer edge, the piston having a second sidewall extending from the outer edge; and
a second seal disposed on the outer edge, the first and second seals lying on a same plane when the first and second ledges lie adjacent one another.
